(19) United States
(12) Patent Application Publication
(10) Pub. No.: US 2004/0039616 A1
(43) Pub. Date: Feb. 26, 2004

(54) System and method for use in connection with human travel

(76) Inventors: Higinio O. Maycotte, Austin, TX (US); Ernesto Vazquez, Austin, TX (US); James L. Stanislaus, Austin, TX (US); Michael J. Scott, Austin, TX (US)

Correspondence Address: TOLER & LARSON & ABEL L.L.P., PO BOX 29567, AUSTIN, TX, 78755-9567, US

(21) Appl. No.: 10/334,693

(22) Filed: Dec. 31, 2002

Related U.S. Application Data
(60) Provisional application No. 60/405,938, filed on Aug. 26, 2002.

(51) Int. Cl. G06F 17/60

(52) U.S. Cl. 705/5; 705/1

(57) ABSTRACT

In a particular embodiment, a computer system for use in connection with human travel is disclosed. The computer system comprises a first data parsing element responsive to a first travel related data input feed; a second data parsing element responsive to a second travel related data input feed; a data server responsive to the first data parsing element and the second data parsing element; and a client facing module responsive to the data server. The client facing module provides a modular interface to communicate with an external computing client device. In another embodiment, a method of using a modular computer system is disclosed. The method comprises parsing a first travel related data input feed at a first modular data parsing element to produce a first parsed travel data input; processing the first parsed travel data input at a data server coupled to the first modular data parsing element to produce processed travel data; receiving the processed travel data at a first modular client pool element; and communicating the processed travel data to an external client device using the first modular client pool element.

### CROSS-REFERENCE TO RELATED APPLICATION(S)

The present application claims priority from U.S. provisional patent application No. 60/405,938, filed Aug. 26, 2002, entitled “Monitoring The Status and Situation of National Air Space Stakeholders”, by Maycotte et al., which is incorporated by reference herein in its entirety.

This application is related to co-pending U.S. application Ser. No. 10/300136, filed Nov. 20, 2002, and having attorney docket number 1003-0002, entitled “Passenger Status Based on Flight Status Information,” by Maycotte et al.

This application is related to co-pending U.S. application Ser. No. 10/300561, filed Nov. 20, 2002, and having attorney docket number 1003-0003, entitled “Automated Collection of Flight Reservation System Data,” by Maycotte et al.

This application is related to co-pending U.S. application Ser. No. 10/300560, filed Nov. 20, 2002, and having attorney docket number 1003-0004, entitled “System and Method to Support End-to-End Travel Service Including Disruption Notification and Alternative Flight Solutions,” by Maycotte et al

This application is related to co-pending U.S. Application filed the same date as this application and having attorney docket number 1003-0006, entitled “Travel Interface and Communication of Travel Related Information via a Computer System,” by Maycotte et al.

### BACKGROUND

1. Field of the Invention

The present invention relates generally to computer systems and methods for use in connection with human travel.

2. Description of the Related Art

Imagine you are on your way to the airport about one hour before your flight is scheduled to depart. Unknown to you, the flight has been cancelled, but you continue to rush, park your car and sprint through security only to arrive at a 20-person line at the gate. By the time you get to the gate agent, the next available flight has been booked full and you've missed the next two connections. Your trip has now been delayed 4-5 hours.

Currently, flight data is monitored and distributed to airlines by the FAA while passenger data is aggregated by Customer Reservation Systems (CRS) such as SABRE and Galileo, and utilized by travel agents. Today there is no efficient integration of the two independent systems. For instance, when the FAA makes decisions about flights to be cancelled, neither the FAA nor the airlines have any requirement (nor is there any automatic notice) to provide this data to a travel agent or its customers. It is usually the passenger who notifies the travel agent after the airlines has had sufficient time to re-book and re-schedule passengers at their will.

Airline delays are at an all time high. Over a quarter of flights were delayed in the year 2000. The traveling public loses over $2 billion due to the chronic flight delays that plague the domestic air travel industry.

Now imagine the desirability of a new service where you are on your way to the airport and you receive a phone or electronic message from your travel agent informing you of the flight cancellation and your subsequent re-booking on another airline just 30 minutes after your original departure time. You are able to make your connecting flight and no trip time has been lost due to flight delays.

Travel agents distribute a significant portion of tickets for the air travel market. Due to airline commission reductions these agents are seeking additional value added services.

As a result, it would be desirable for travelers to receive a maximum level of alternate travel options when a delay occurs, and have their problem resolved automatically by their travel agent. While the travel disruption problem has been described by way of an airline example, travel disruptions occur in many different transportation industries. Accordingly, there is a need for improved system and method for providing travel disruption notification and for responding to such disruptions.

### SUMMARY

In a particular embodiment, a computer system for use in connection with human travel is disclosed. The computer system comprises a first data parsing element responsive to a first travel related data input feed; a second data parsing element responsive to a second travel related data input feed; a data server responsive to the first data parsing element and the second data parsing element; and a client facing module responsive to the data server. The client facing module provides a modular interface to communicate with an external computing client device.

In another embodiment, a method of using a modular computer system is disclosed. The method comprises parsing a first travel related data input feed at a first modular data parsing element to produce a first parsed travel data input; processing the first parsed travel data input at a data server coupled to the first modular data parsing element to produce processed travel data; receiving the processed travel data at a first modular client pool element; and communicating the processed travel data to an external client device using the first modular client pool element.

### BRIEF DESCRIPTION OF THE DRAWINGS

FIG. 1 shows a general process that illustrates transportation paths.

FIG. 2 is an illustrative end-to-end trip lifecycle.

FIG. 3 is a plurality of potential disruption points along a travel path.

FIG. 4 is an illustrative system for monitoring travel paths.

FIG. 5 is an illustrative system to monitor flight travel.

FIG. 6 is a flow diagram that illustrates a method of determining and responding to a travel disruption.

FIG. 7 is a flow diagram that illustrates the method for monitoring the status and situation of any National Air Space (NAS) stakeholder.

FIG. 8 is a passenger situational display interface (PSDI) that is used to display status and situation of any National Air Space (NAS) stakeholder.

FIG. 9 is a flow diagram that illustrates a method for responding to a travel disruption.

FIG. 10 is a detailed example of a system to provide monitoring and communication of disruption events.

FIG. 11 is a flow chart that further illustrates a method of providing alternative travel arrangements.

FIG. 12 is a block diagram that illustrates an embodiment of a computer system architecture.

The use of the same reference symbols in different drawings indicates similar or identical items.

### DETAILED DESCRIPTION

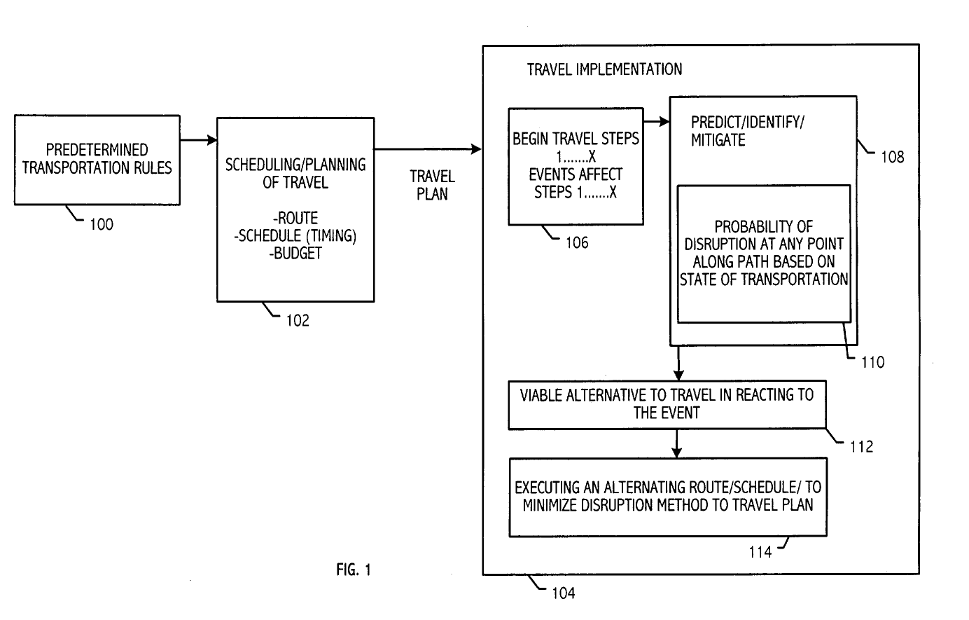

Referring to FIG. 1, a general process that illustrates transportation paths is shown. A predetermined set of transportation rules are generated at 100 and input to a process for scheduling/planning of travel, at 102. The scheduling/planning fuinction 102 includes determining appropriate travel route, scheduling and budget allocations. The output of the scheduling/planning function 102 is a travel plan which is received as an input into the travel implantation process 104.

During the travel implementation process, physical travel, such as airplane flights or other transportation beginning at 106. During the physical travel path, various disruptive events may affect the travel. A prediction engine 108 may be used to determine and predict the probability of disruptions at various points along the travel path based on a state of transportation, at 110. In the case where a travel disruption is predicted with a high degree of certainty, a viable alternative to travel is created to respond to the disruption event, at 112. The alternative travel path is provided and an alternative route/schedule may be executed to minimize or at least reduce the disruption from the original travel plan, at 114.

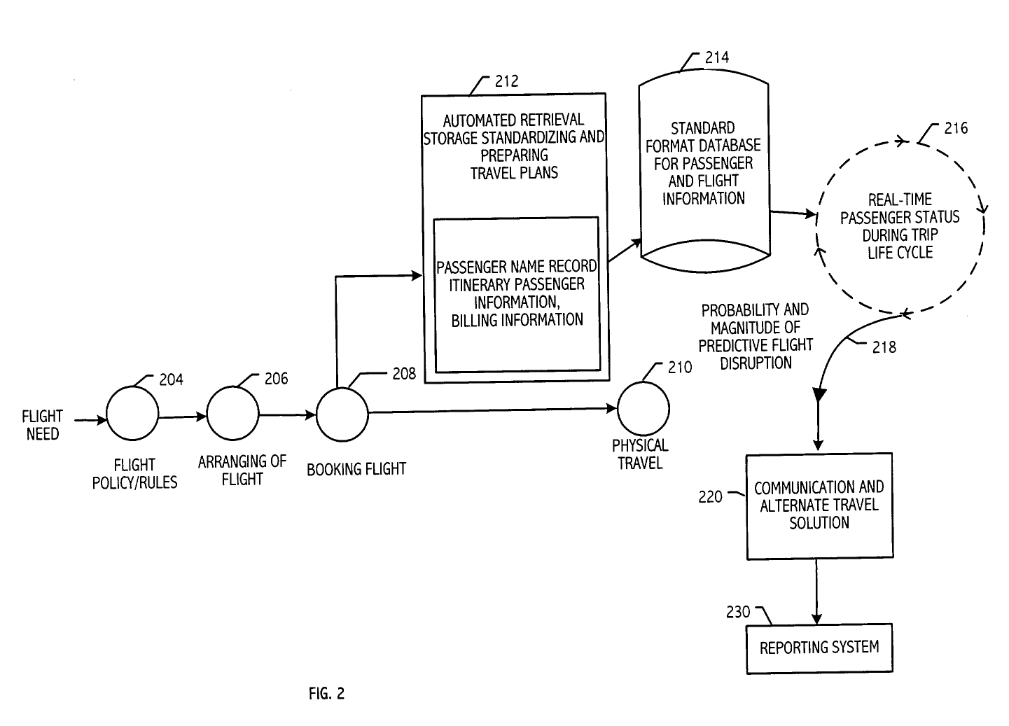

Referring to FIG. 2, an illustrative end-to-end trip lifecycle is shown. The lifecycle includes an original need for a flight, such as a need determined by a passenger arranging a trip. The flight need is input to a set of flight policy and rules determination, at 204, and a flight is arranged, at 206. The arranging step 206 includes pricing and availability determination. As part of the flight arrangement, other factors may be considered such as the probability of a flight disruption based on historical and other disruption predication information. The arranged flight is then booked, at 208, and physical travel for that flight occurs, at 210. After booking a flight, at 208, a computerbased system 212 may be used to automatically retrieve and store, as well as standardize travel plans. As part of the automated retrieval and standardizing process, a passenger name record, itinerary passenger information, and billing information is received, stored, and then standardized for further analysis. The standard format for passenger flight information is then transferred by the system 212 to a database 214.

Real-time passenger status during the trip is continually determined and updated through a physical travel life cycle at 216. One output of the real-time passenger status is a probability and magnitude of a potential flight disruption 218. The probability and magnitude data 218 is fed to a communication and alternate travel solution module 220. Output from the communication and alternate travel solution module 220, such as a notification of a disruption event accompanied by alternate travel plans, is sent to a reporting system 230. The reporting system 230 may be used to communicate with passengers, airlines, and travel agents.

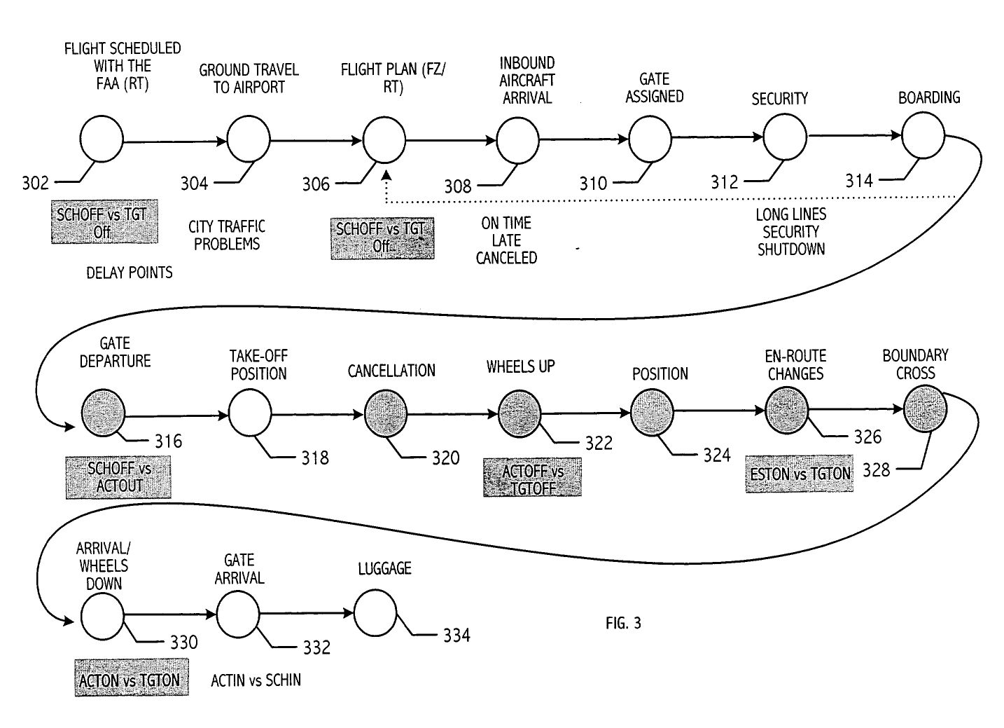

Referring to FIG. 3, a plurality of potential disruption points along a travel path is illustrated. A first potential disruption point is the point when the flight scheduled with the FAA, at 302. The next potential disruption event point is the ground travel to airport point 304. Additional potential disruption points include flight plan 306, inbound aircraft arrival 308, gate assigned point 310, security clearance point 312, flight boarding point 314, gate departure 316, take-off position 318, cancellation 320, wheels up 322, flight position 324, en-route changes 326, boundary cross 328, arrival/wheels down 330, gate arrival 332, and luggage available 334. At each of the disruption points, such as those illustrated in FIG. 3, a measurement may be taken comparing real-time actual location versus the travel plan and target. In the case where a flight is delayed, cancelled or where a disruption occurs, such as weather condition, maintenance issue, or any other scenario affecting travel plans, a disruption condition or a high probability of a disruption condition occurring may be determined. By determining disruption condition events at each of a plurality of potential disruption points, an early indication of disruption may be determined.

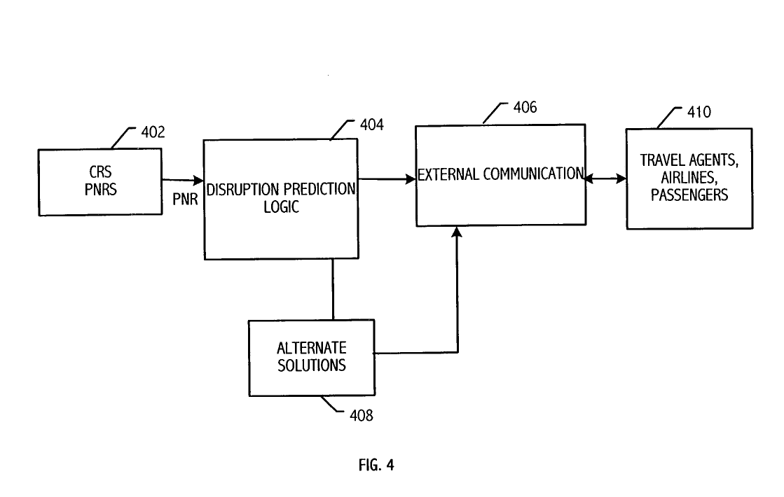

Referring to FIG. 4, an illustrative system for monitoring travel paths, determining disruption events, and for providing communications with travel industry stakeholders is illustrated. The system includes a customer reservation system 402, a disruption prediction logic subsystem 404, an external communication subsystem 406, alternate travel solutions system 408, and external systems 410, including travel agent systems, airlines and those used by passengers. The customer reservation system (CRS) 402 includes passenger name records and may be an automated airline system, such as that provided by Sabre. The disruption prediction logic 404 retrieves the passenger name records (PNR) from the customer reservation system 402 and processes those passenger name records. In the case where a disruption event is detected by prediction logic 404, an alternative travel solution is determined by the alternate solution system 408 and notification of the disruption event as well as the alternate solution is provided by the external communication system 406. Such communication provides notification of disruption events, such as notice of delay condition to travel agents, airlines, and flight passengers 410.

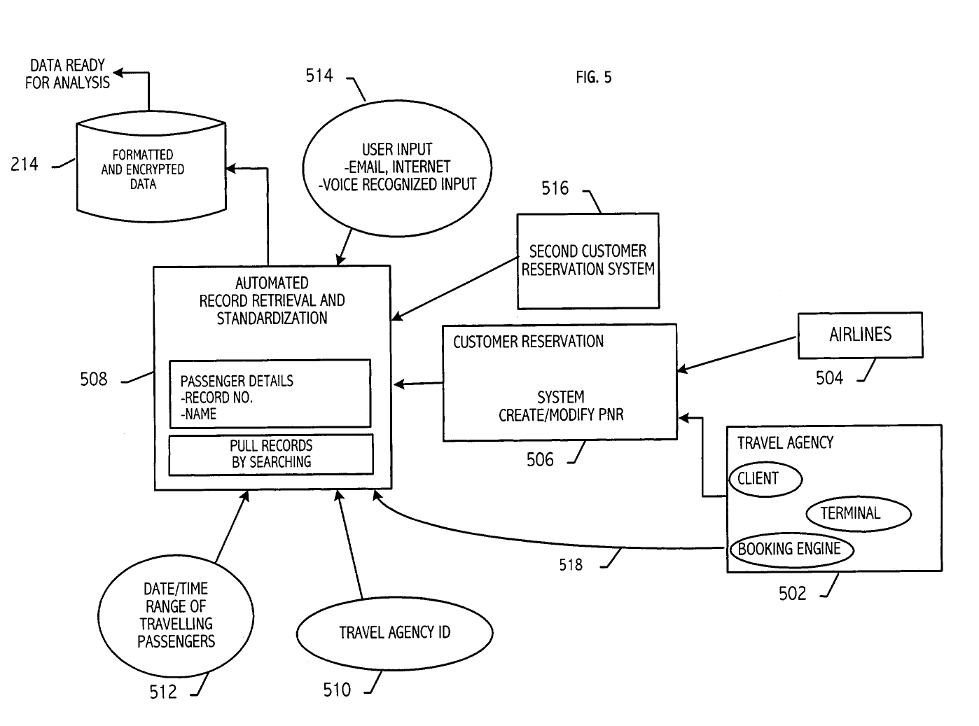

Referring to FIG. 5, an illustrative system to monitor flight travel is shown. The system includes a travel agency system 502, airline systems 504, customer reservation system 506, automated record retrieval standardization module 508, and an optional second customer reservation system 516. The automated record retrieval and standardization system 508 receives a travel agency ID 510, data/time range of traveling passengers 512, and user input such as received via email, internet, and voice recognized user input 514. The illustrated system also includes data storage 214 that includes the formatted and encrypted/standardized data which is ready for analysis.

The travel agency computer system 502 may include a travel agency terminal, an intemet booking engine, and a client software module. The travel agency computer system 502 is also connected to the airline customer reservation system (CRS) 506, so that a travel agent at a terminal may schedule and book flights. The term travel agent includes any advocate of a potential passenger that has authority to create or modify a travel plan. The customer reservation system 506 may be used to create and modify passenger name records (PNR) and receives information, including modified PNRs, from the airlines 504. The illustrated system may also be used with additional customer reservation systems, such as the second customer reservation system 516. The travel agency computer system 502 also has a direct data feed 518 to the automated record retrieval and standardization system 508. The direct data feed 518, in a particular example may be a direct or remote communication path, such as a local or wide area network. The automated record retrieval and standardization system 508 may be used to retrieve and pull flight records by using various searching methods, may determine passenger detail such as name and various record numbers, and may reformat text and data to provide for a standardized format of information.

The automated record retrieval and standardization system 508 receives a travel agency ID 510 and a time range of traveling passengers 512 including date of travel information. With the travel agency ID 510 and the date and time range of traveling passengers 512, a subset of the records from the CRS 506 and/or CRS 516 may be searched through to pull a defined and filtered set of selected passenger records. This subset of passengers based on a particular travel agency defined criteria is then standardized and may optionally be encrypted for subsequent analysis after storage in the database 214. The automated record retrieval and standardization system 508 also may receive user input such as via certain internet travel sites, email, and alternative user input, such as via voice recognition. The automated record retrieval and standardization system 508 utilizes all such received information to produce a set of passenger information that may be easily analyzed for various record requests.

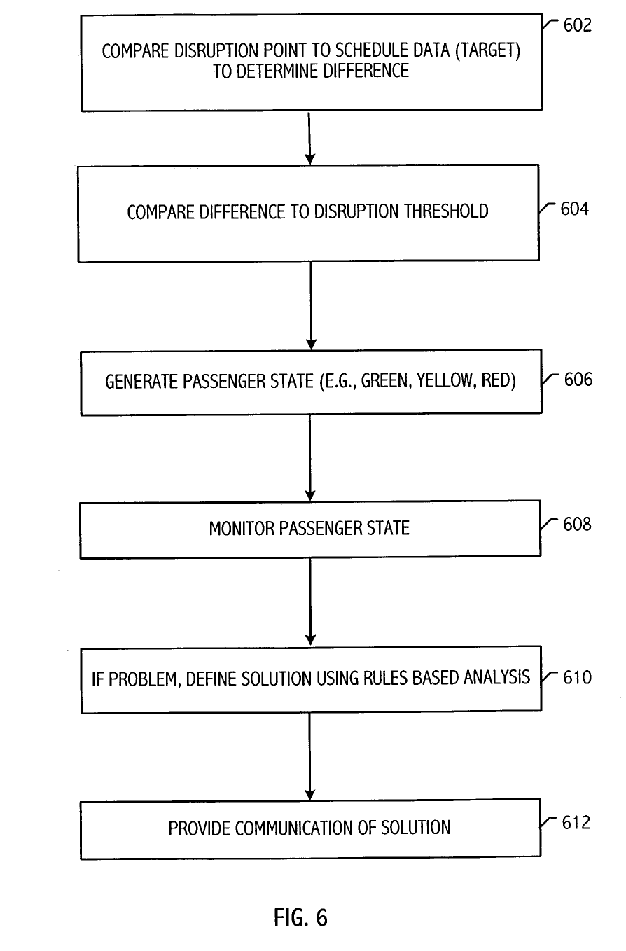

Referring to FIG. 6, a method of determining and responding to a travel disruption is illustrated. In a particular disruption point along a travel path, the schedule data, also referred to as target data, is compared to actual monitored real time data to determine a difference measurement, at 602. The difference measurement is then compared to a disruption threshold, at 604. A passenger state is then generated, at 606. The passenger state may be a particular disruption activity level. One method of indicating disruption potential is by providing a set of three different disruption levels. In this example, a green status indicates little or no disruption, a yellow status would indicate a warning of potential disruption, and a red indication would mean a determined or very high likelihood disruption event condition. While the illustrated method uses three different disruption levels, it should be understood that a set of two or many more different disruption levels may be used to indicate a disruption condition. The passenger state information is monitored, at 608, and if a problem is detected, an alternate solution using a rules-based analysis is determined, at 610. An example of an alternate solution could be taking a different flight or may be scheduling alternate means of transportation, such as a bus, train rental car, etc. The alternate solution in response to the disruption event is then communicated, at 612.

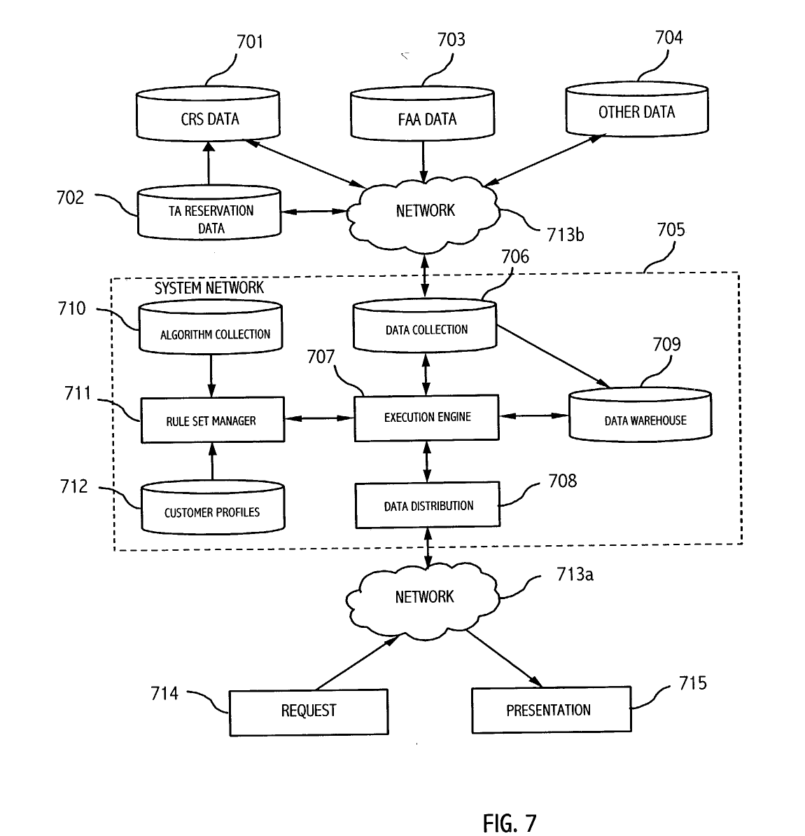

Referring to FIG. 7, a method for monitoring the status and situation of any National Air Space (NAS) stakeholder, including any passenger, before, during and after that stakeholder enters NAS is illustrated. The stakeholder status is determined by aggregating Travel Agency (TA) passenger reservation data at 702, central reservation system (CRS) data at, 701, real-time enhanced traffic management system (ETMS), air traffic data from the FAA, at 703, and other data including real-time weather data, airport status, etc. at, 704.

This data is aggregated across public and private networks 713b and received into the system network, at 705. All data is then collected, parsed, sorted and stored at 706. This data is then combined with various algorithms 710, profile data 712, and warehoused historical data 709, to yield a stakeholder status. Based on the stored algorithms 710 and the stakeholder status, certain reactions take place in an execution engine, at 707. The execution engine then disseminates the appropriate data either automatically or in response to a client request, at 714, via the data distribution system, at 708. This data is then distributed across public and private networks 713a to a client for presentation, at 715.

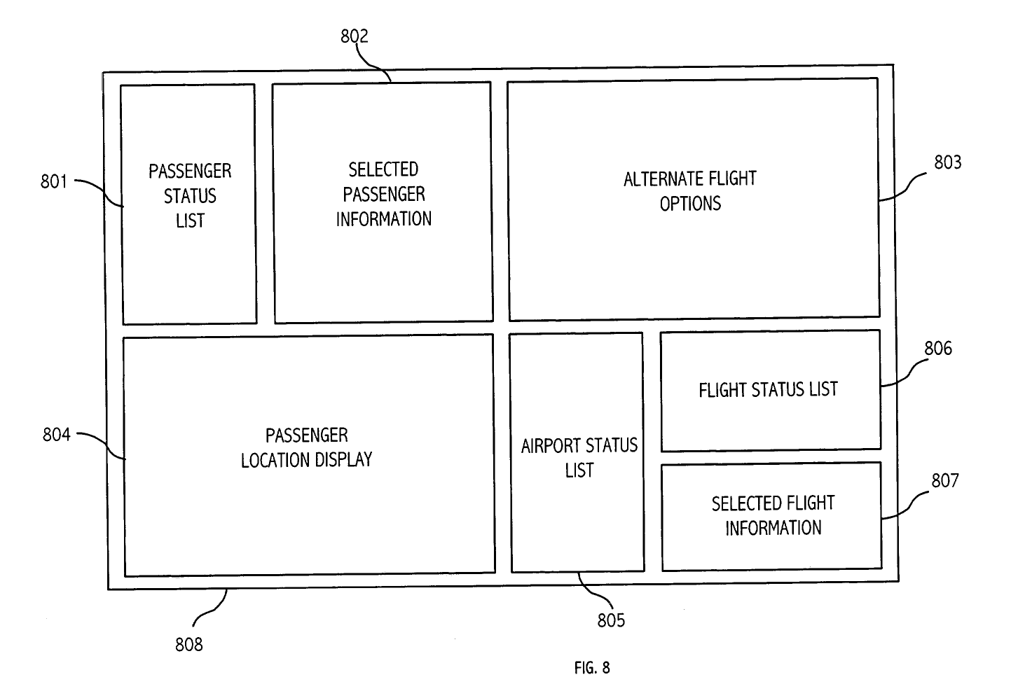

Referring to FIG. 8, the passenger situational display interface (PSDI) is a client system used to display status and situation of any National Air Space (NAS) stakeholder. The Java client displays passenger location 804, airport status 805, flight status list 806, selected flight information 807, flight passenger list 801, selected passenger information 802, and the alternate flight options 803. This information is also available for any computing platform via Microsoft Windows Client, HTML, XML, WAPI and others. This PSDI will allow additional windows and information to be displayed such as weather, news, pricing information and others.

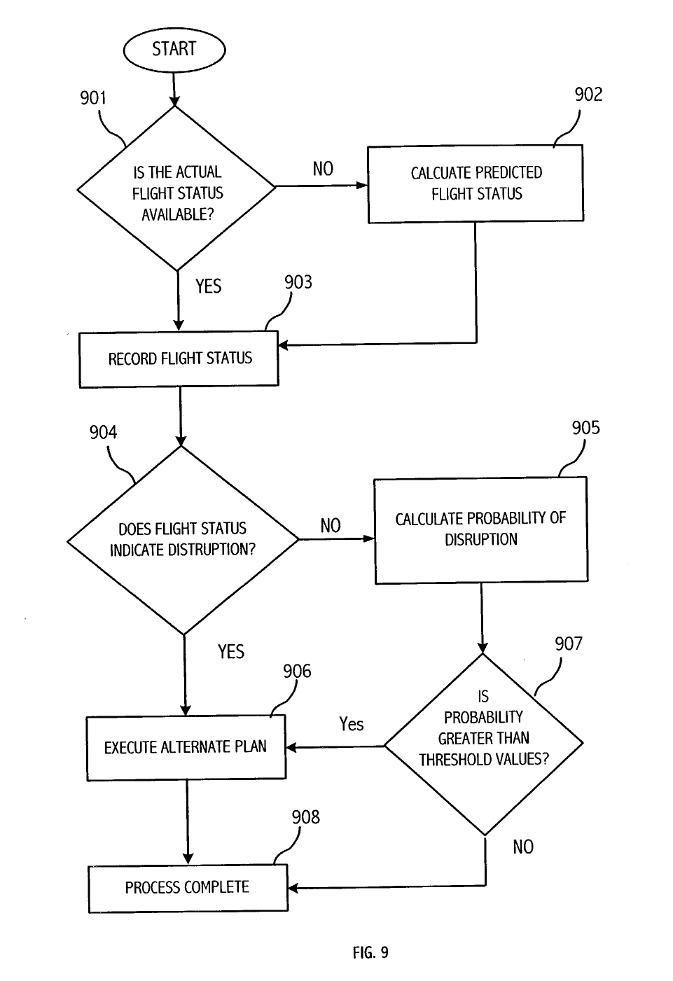

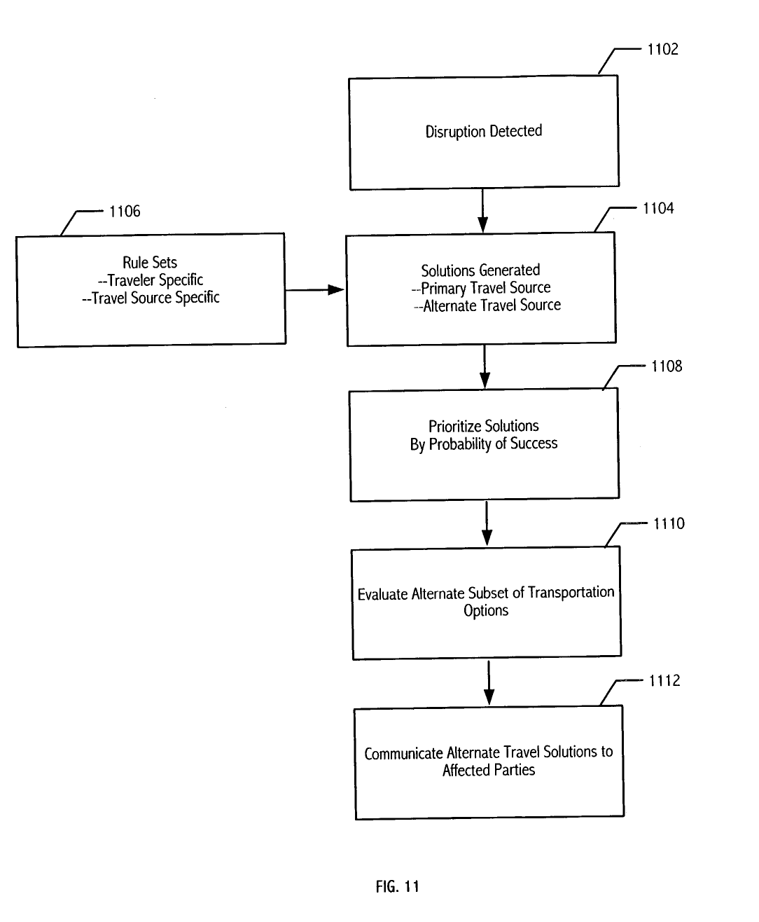

Referring to FIG. 9, when a passenger has an active reservation, a method for determining whether alternate flights should be booked for that particular passenger is illustrated. If the flight status is available, at 901, then flight status is recorded, at 903. If the flight status is not available, a predicted flight status is calculated, at 902. If the determined status indicates a disruption event, such as a flight cancellation or delay, at 904, then an alternate travel plan is arranged, at 906. If the status does not indicate a disruption, then the probability of a disruption is calculated, at 905. If the calculated probability is greater than a predetermined threshold value 907, then an alternate travel plan for the passenger is determined and executed, at 906. An example of a method of determining and executing an alternate travel plan is illustrated below with reference to FIG. 11. If the probability threshold is less than the predetermined threshold value, then the process is complete, at 908.

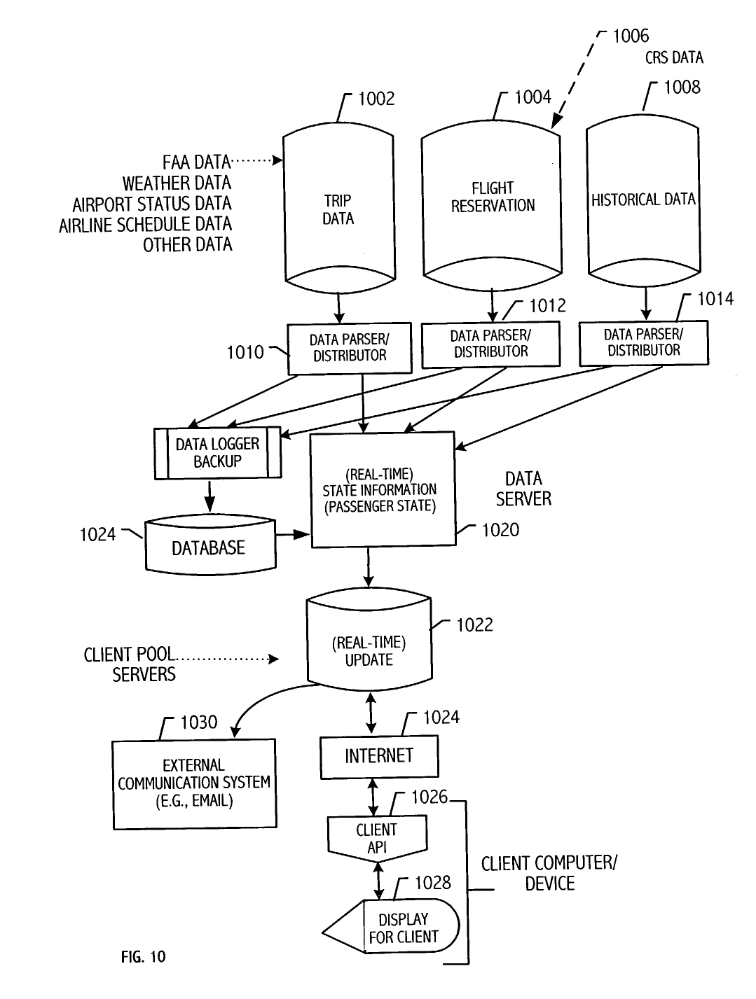

Referring to FIG. 10, a detailed example of a system to provide monitoring and communication of disruption events is shown. The system includes a real-time state information logic module 1020, and an updated real-time status system 1022. The real-time state information logic routine 1020 may be embedded within a data server. The real-time state information logic receives input from various data parsers/distributors, such as data parser/distributors 1010, 1012, and 1014. The first data parser/distributor 1010 receives trip data 1002, the second data parser/distributor 1012 receives flight reservation information 1004, and the third data parser/distributor 1014 receives historical data 1008. The flight reservation information 1004 may be retrieved from customer reservation system data 1006. The trip data 1002 may be received from various sources including FAA data, weather data, airport status data, airline schedule data, and other data that can affect on the travel. A data logger and backup function is also implemented and receives data from the various parsers 1010, 1012, and 1014. The data logger/backup also includes and may be implemented using a database 1024 to store needed information. A pool of client servers may be used in a particular implementation to perform the real-time update function 1022. During a real-time update, when a change in passenger state disruption level is determined, a notification and/or communication event may be triggered. Such communication may be a proprietary system handled over the internet 1024 using a client application program interface (API) 1026 and displayed on a particular client device 1028. Alternatively, a communication of the disruption event may be handled via external communication system 1030, such as using email or other notification technology.

Referring to FIG. 11, in the event of a flight disruption, the system generates an alternate travel arrangement. When a flight disruption event occurs, at 1102, the system may generate possible alternate travel arrangements, at 1104, from the primary travel source (i.e. airline flights) and then check these options against a set of rules, at 1106, determined by the traveler, such as a corporate travel policy. The alternate options are also checked against a set of rules 1106, created by the transporting entity, such as a list of fare/class rules or airline ticketing policies. The system should then determine the likely probability of success, at 1108, of an alternate travel solution, based on these rules. If no viable options meet or exceed a predetermined probability of success from the primary transportation options, an alternate subset of transportation options may then be explored, at 1110, such as private charters, car rentals, or hotel reservations. The resulting alternate travel solutions are communicated to affected parties, such as the traveling entity or travel agent, at 1112.

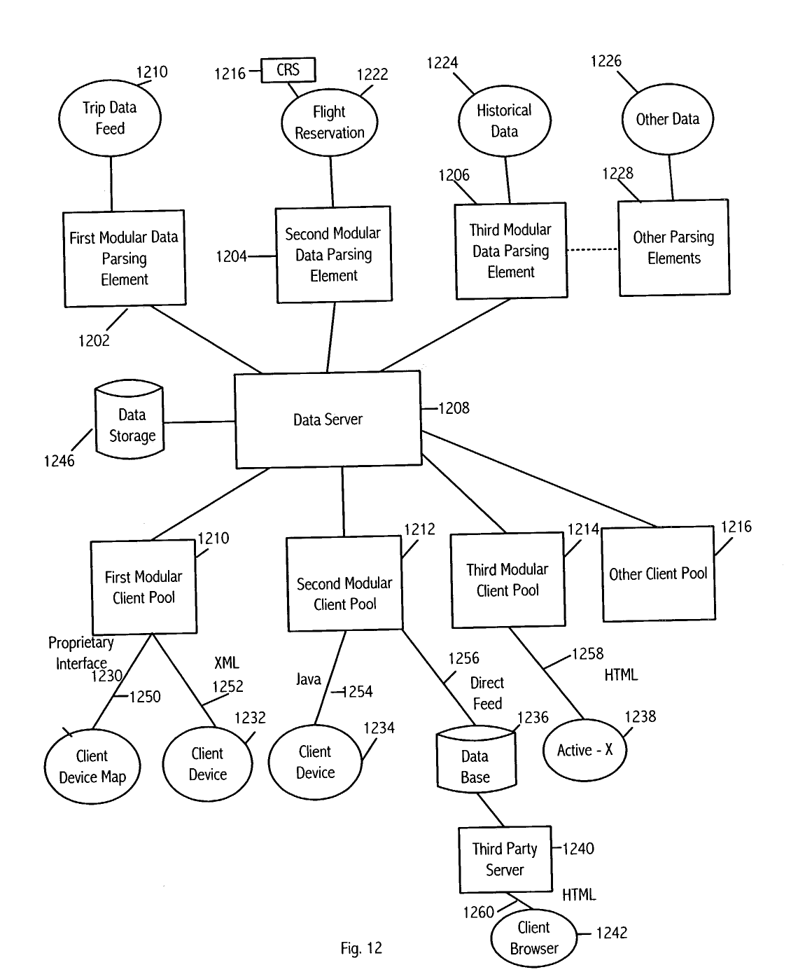

Referring to FIG. 12, a computer system is illustrated. The computer system includes a plurality of modular data parsing elements 1202, 1204, 1206, 1228, a data server 1208, and a plurality of modular client pool elements 1210, 1212, 1214, 1216. The data server 1208 is coupled to a data storage unit 1246. The data server 1208 is responsive to each of the modular data parsing elements 1202, 1204, 1206, and 1228 and is coupled to each of the modular client pool elements 1210, 1212, 1214, and 1216. The data server 1208 includes software logic that provides for the travel disruption and travel solution functionality described above.

Each of the plurality of modular parsing elements has an input to receive data from a travel industry related data feed. For example, the first modular data parsing element 1202 receives trip data from trip data feed 1210, the second modular data parsing element 1204 receives flight reservation data from the flight reservation data feed 1222, and the third modular data parsing element 1206 receives historical data from the historical data repository 1224. The flight reservation data 1222 is received from a representative external customer reservation system 1216.

The optional parsing elements, represented as other parsing elements 1228, may likewise receive additional input data from other data feeds 1226 that may be added as needed or desired. Thus, to add additional input to be considered by software programs and logic within the data server, an additional modular data parsing element may simply be added to receive and parse data from a new desired input data feed. This architecture advantageously provides a modular, scalable, and flexible system that may be easily adapted and changed as required. An example of an additional data feed could be a weather prediction feed. For this example, a special weather parsing element could be produced to interpret the data from the added weather input data feed, without requiring any reprogramming of the other parsing elements or the data server 1208.

Each of the modular client pool elements 1210, 1212, 1214, 1216 are coupled to different available external devices and/or systems for use by customers and travel users. For example, the first modular client pool 1210 is coupled over a proprietary interface 1250 to a client device that displays a travel map 1230. This proprietary interface 1250 may be a connection to a travel agency system with custom software to provide a customized map display for use by the particular travel agency and its agent users. The first modular client pool 1210 is also coupled to a client computing device 1232 via an open interface, such as the public standard XML interface 1252. An example of a client computing device is a personal computer, a portable computer, or a hand-held personal digital assistant (PDA). The client device 1232 may receive notification from the first modular client pool 1210 of predicted or early detected travel disruptions and of alternate travel recommendations in the event of such disruptions.

As a further example, the second modular client pool 1212 is coupled to a client device 1234 via another type of public interface, such as the Java standard interface 1254. The second modular client pool 1212 may also be coupled to a proprietary database 1236 via a direct data feed 1256. This proprietary database 1236 may be coupled to an external third party server 1240, which may in turn be used to support a plurality of public internet users 1242 via an industry standard interface, such as the internet HTML interface 1260 as shown. In this example, a third party service provider may receive travel disruption and other travel data from the second modular client pool 1212, and may integrate such data with other data and programs at the external server 1240 to provide for an enhanced service for additional customers via the internet.

As a further example, the third illustrated modular client pool 1214 is coupled to a client computing device using Microsoft Active-X software 1238 via an open interface, such as HTML 1258. An example of the client computing device is a personal windows type of computer having an internet connection. By using a plurality of different modular client pool elements, many different types of client devices and communication interfaces may be supported in a flexible and scalable manner. To add support for additional client computers and additional interfaces, the system may be expanded easily by adding additional modular client pool elements, as illustrated by the representative client pool element 1216.

During operation, travel related data is received and then parsed by the parsing elements 1202, 1204, 1206, 1228 to produce data with a common format that is passed to the data server 1208 for processing. Part of the data processing within the server 1208 is to detect travel disruption events and to produce alternate travel solutions after detecting such events. The processed data is then forwarded from the data server 1208, after updating the stored records within data storage unit 1246, to each of the respective modular client pools 1210, 1212, 1214, and 1216. Each of the client pools receives the processed travel data and converts the received data from the common output format produced by the data server 1208 to an applicable external interface for communication to external client computers and third party systems, such as the illustrated devices and systems 1230, 1232, 1234, 1240, and 1238. The external computing devices then receive updates to travel data as applicable, such as in the event of a new detected disruption event.

According to the foregoing description, various embodiments of the present invention have been described with particularity. The above-disclosed subject matter has been described in reference to particular illustrative embodiments and by way of example. The appended claims are intended to cover all modifications, variations, and other implementations which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer system for use in connection with human travel, the computer system comprising:
a first data parsing element responsive to a first travel related data input feed;
a second data parsing element responsive to a second travel related data input feed;
a data server responsive to the first data parsing element and the second data parsing element; and
a client facing module responsive to the data server, the client facing module providing a modular interface to communicate with an external computing client device.

2. The computer system of claim 1, wherein the first travel related data input feed comprises trip data and the second travel related data input feed comprises flight reservation information.

3. The computer system of claim 2, wherein the flight reservation information is associated with reservations of a set of airline passengers.

4. The computer system of claim 3, wherein the data server includes logic to determine flight reservation data associated with reservations of a set of airline passengers.

5. The computer system of claim 4, wherein the logic within the data server further determines flight status data for at least one airplane associated with the reservations of the set of airline passengers and determines a passenger status for each passenger in the set of airline passengers based on the flight reservation data and based on the flight status data.

6. The computer system of claim 5, wherein the passenger status is based on a detected disruption condition associated with the flight of the airplane and wherein the client facing module is used to communicate the disruption condition and an alternate travel plan to at least one of a passenger and a travel agent.

7. The computer system of claim 6, wherein the external computing device is operated on behalf of a travel agency.

8. The computer system of claim 7, wherein the external travel agency computing device is used to rebook an alternate flight after detection of the disruption condition.

9. The computer system of claim 1, further comprising a third data input feed, the third data input feed comprising historical flight related data, and wherein the disruption condition is determined based on real-time flight data from at least one of the first and second input data feeds, and based on the historical data.

10. The computer system of claim 1, wherein a disruption condition is determined by the data server comparing real-time airline data at various disruption points against scheduled times for the associated disruption points.

11. The computer system of claim 2, wherein the first input travel related data is selected from the group of Federal Aviation Association data, weather data, airport status data, and airline schedule data.

12. The computer system of claim 1, wherein the second input travel related data includes flight information received from an airline customer reservation system.

13. The computer system of claim 1, wherein the client facing module includes a first client pool server and a second client pool server.

14. The computer system of claim 13, wherein the first client pool server provides a first type of client interface to a first set of external client devices and the second client pool server provides a second type of client interface to a second set of external client devices.

15. The computer system of claim 14, wherein the first type of client interface supports at least one public interface and wherein the second type of client interface supports a proprietary interface.

16. The computer system of claim 15, wherein the public interface is at least one of an HTML interface, a WAP interface, an Active-X Windows computer interface, a JAVA interface, and an XML interface.

17. The computer system of claim 14, wherein the first client pool server is modular and separable from the second client pool server.

18. A method of using a modular computer system, the method comprising:
parsing a first travel related data input feed at a first modular data parsing element to produce a first parsed travel data input;
processing the first parsed travel data input at a data server coupled to the first modular data parsing element to produce processed travel data;
receiving the processed travel data at a first modular client pool element; and
communicating the processed travel data to an external client device using the first modular client pool element.

19. The method of claim 18, further comprising providing a second modular data parsing element, wherein the data server is responsive to the first modular data parsing element and is responsive to the second modular data parsing element.

20. The method of claim 19, further comprising providing a second modular client pool element that is responsive to the data server.

21. The method of claim 20, further comprising providing a third modular data parsing element and providing a third modular client pool element.

22. The method of claim 20, wherein the first modular data parsing element receives flight trip data and the second modular data parsing element receives flight reservation data.

23. The method of claim 22, wherein the flight reservation information is associated with reservations of a set of airline passengers.

24. The method of claim 23, further comprising determining flight reservation data associated with reservations of the set of airline passengers.

25. The method of claim 24, further comprising determining flight status data for at least one airplane associated with the reservations of the set of airline passengers and determining a passenger status for each passenger in the set of airline passengers based-on the flight reservation data and based on the flight status data.

26. The method of claim 25, wherein the passenger status is based on a detected disruption condition associated with the flight of the airplane and wherein at least one of the first modular client pool element, the second modular client pool element, and the third modular client pool element, communicate the disruption condition and an alternate travel plan to at least one of a passenger and a travel agent.
